(19) United States
(12) Patent Application Publication
(10) Pub. No.: US 2010/0138089 A1
(43) Pub. Date: Jun. 3, 2010

(54) Hybrid electric vehicle system and method for initiating and operating a hybrid vehicle in a limited operation mode

(75) Inventor: Christopher O. James, San Diego, CA (US)

Correspondence Address: PROCOPIO, CORY, HARGREAVES & SAVITCH LLP, 530 B STREET, SUITE 2100, SAN DIEGO, CA, 92101, US

(73) Assignee: ISE CORPORATION, Poway, CA (US)

(21) Appl. No.: 12/496,024

(22) Filed: Jul. 1, 2009

(51) Int. Cl. B60W 10/04; G06F 19/00; B60W 20/00

(52) U.S. Cl. 701/22; 477/3; 180/65.21

(57) ABSTRACT

A system and method for initiating a limited operation mode and operating the hybrid electric vehicle in the limited operation mode is described. The system includes a user interface associated with the hybrid electric vehicle, an operating mode device and a control module. The operating mode device is coupled to the user interface and is configured to initiate one or more vehicle operation modes including a limited operation mode. The operating mode device is further configured to deactivate a second vehicle operation mode if the second vehicle operation mode is currently active in response to initiating the limited operation mode. The control module is coupled to the operating mode device. In some embodiments the control module is configured to generate commands for limiting the hybrid electric vehicle operational performance characteristics when the hybrid electric vehicle is in the limited operation mode.

### FIELD OF THE INVENTION

This invention relates to hybrid electric vehicles which combine a conventional propulsion system with high power electric drive systems. In particular, the invention relates to systems and methods for initiating a limited operation mode and operating the hybrid electric vehicle in the limited operation mode.

### BACKGROUND OF THE INVENTION

In recent times, hybrid electric vehicles (HEVs) which reduce the amount of emissions and achieve better fuel economy are attracting a lot of attention over internal combustion engine (ICE) vehicles. While HEVs are commonly associated with automobiles, heavy-duty hybrids also exist. In the U.S., a heavy-duty vehicle is legally defined as having a gross weight of over 8,500 lbs. A heavy-duty HEV will typically have a gross weight of over 10,000 lbs. and may include vehicles such as a metropolitan transit bus, a refuse collection truck, a semi tractor trailer, etc. Increasing fuel prices and the many benefits of HEV's have prompted increasing numbers of vehicle operators to purchase HEVs. In fact, the numbers of commercial HEV vehicle fleets is growing as well.

FIG. 1, illustrates a schematic of a hybrid-electric drive system. Here HEV drive system 100 is shown in a series configuration, however, HEV drive systems may also be in a parallel configuration (not shown). HEV drive system 100 will commonly use an energy generation source such as a fuel cell (not shown) or an “engine genset” 110 comprising an engine 112 (e.g., ICE, H-ICE, CNG, LNG, etc.) coupled to a generator 114, and an energy storage pack or module 120 to provide electric propulsion power to its drive wheel propulsion assembly 130. In particular, the engine 112 (here illustrated as an ICE) will drive generator 114, which will generate electricity to power one or more electric propulsion motor(s) 134 and/or charge the energy storage 120.

The energy storage pack or module 120 may be made up of a plurality of energy storage cells 122 (e.g., battery, ultracapacitor, flywheel, etc.) electrically coupled in series, increasing the pack's voltage. Alternately, energy storage cells 122 may be electrically coupled in parallel, increasing the pack's current, or both in series and parallel. During operation, energy storage 120 may solely power the one or more electric propulsion motor(s) 134 or may augment power provided by the engine genset 110. The energy storage design may vary in light of the vehicle's drive cycle, its physical parameters, and its performance requirements. For example, energy storage pack 120 for heavy-duty vehicles (here, having a gross weight of over 10,000) may include 288 ultracapacitor cells, the pack having a rated DC voltage of 650 VDC and storing 750 Wh of energy.

HEVs may include a mode of operation where the vehicle operates with its engine shut down, running entirely off stored energy. This is sometimes called “EV mode”, as the HEV is operating as a purely electric vehicle. In contrast, under normal conditions, the HEV is operating in “Hybrid mode”, wherein the engine runs as needed to generate electricity and/or drive torque. EV mode will generally require a minimum state of charge (SOC) in the energy storage 120 to operate the vehicle and to prevent energy storage damage associated with deep discharging. The minimum SOC is typically high enough to give the driver acceleration on demand and to minimize oscillations of the ICE's operation.

Multiple electric propulsion motor(s) 134 may be mechanically coupled via a combining gearbox 133 to provide increased aggregate torque to the drive wheel assembly 132 or increased reliability. Heavy-duty HEVs may operate off a high voltage electrical power system rated at over 500 VDC. Propulsion motor(s) 134 for heavy-duty vehicles (here, having a gross weight of over 10,000) may include two AC induction motors that produce 85 kW of power (×2) and having a rated DC voltage of 650 VDC.

Unlike lower rated systems, heavy-duty high power HEV drive system components may also generate substantial amounts of heat. Due to the high temperatures generated, high power electronic components such as the generator 114 and electric propulsion motor(s) 134 will typically be cooled (e.g., water-glycol cooled), and may also be included in the same cooling loop as the ICE 112.

Since the HEV drive system 100 may include multiple energy sources (i.e., engine genset 110, energy storage device 120, and drive wheel propulsion assembly 130 in regen), in order to freely communicate power, these energy sources may then be electrically coupled to a power bus, in particular a DC high power bus 150. In this way, energy can be transferred between components of the high power hybrid drive system as needed.

A HEV may further include both AC and DC high power systems. For example, the drive system 100 may generate, and run on, high power AC, but it may also convert AC to DC for storage and/or transfer between components across the DC high power bus 150. Accordingly, the current may be converted via an inverter/rectifier 116, 136 or other suitable device (hereinafter “inverters” or “AC-DC converters”). Inverters 116, 136 for heavy-duty vehicles (i.e., having a gross weight of over 10,000 lbs.) are costly, specialized components, which may include a special high frequency (e.g., 2-10 kHz) IGBT multiple phase water-glycol cooled inverter with a rated DC voltage of 650 VDC and having a peak current of 300 A.

As illustrated, HEV drive system 100 includes a first inverter 116 interspersed between the generator 114 and the DC high power bus 150, and a second inverter 136 interspersed between the generator 134 and the DC high power bus 150. Here the inverters 116, 136 are shown as separate devices, however it is understood that their functionality can be incorporated into a single unit.

As a key added feature of HEV efficiency, many HEVs recapture the kinetic energy of the vehicle via regenerative braking rather than dissipating kinetic energy via friction braking. In particular, regenerative braking (“regen”) is where the electric propulsion motor(s) 134 are switched to operate as generators, and a reverse torque is applied to the drive wheel assembly 132. In this process, the vehicle is slowed down by the main drive motor(s) 134, which converts the vehicle's kinetic energy to electrical energy. As the vehicle transfers its kinetic energy to the motor(s) 134, now operating as a generator(s), the vehicle slows and electricity is generated and stored. When the vehicle needs this stored energy for acceleration or other power needs, it is released by the energy storage 120.

This is particularly valuable for vehicles whose drive cycles include a significant amount of stopping and acceleration (e.g., metropolitan transit buses). Regenerative braking may also incorporated into an all-electric vehicle (EV) thereby providing a source of electricity generation onboard the vehicle.

When the energy storage 120 reaches a predetermined capacity (e.g., fully charged), the drive wheel propulsion assembly 130 may continue to operate in regen for efficient braking. However, instead of storing the energy generated, any additional regenerated electricity may be dissipated through a resistive braking resistor 140. Typically, the braking resistor 140 will be included in the cooling loop of the ICE 112, and will dissipate the excess energy as heat.

Looking at the vehicle as whole, HEVs present certain advantages and challenges compared to their conventional ICE counterparts. In general, it is desirable to limit engine exhaust in areas having restricted air flow, and this is especially true in enclosures. For example, in cold environments a vehicle garage may be a closed structure, which would make it toxic or at least unhealthy to permit a vehicle engine to run. As such, in order to reduce health risks, running an ICE in these areas may be limited or prohibited altogether. Analogous considerations exist for noise-sensitive areas. Thus, currently an ICE vehicle may require external propulsion (e.g., a warehouse tug) to move about in a warehouse or otherwise restricted facility, and/or the facility may require extensive ventilation.

A HEV operating in EV mode, however, has the advantage of being able drive under its own power with zero emissions and minimal noise. However, if the vehicle arrives to the zero emissions/noise area without an adequately charged energy storage, the vehicle will not allow EV mode. Accordingly, the operator will need to make sure the energy storage has a sufficient SOC or will need to run the vehicle engine outside the area until the energy storage is sufficiently charged before entering.

At the end of its duty cycle, an HEV such as semi trucks, buses, automobiles, or refuse collection trucks are commonly parked in a garage or structure. In the case of a commercial vehicle fleet, the garage may house both the parking structure and the fleet's vehicle maintenance facility. As above, EV mode provides the advantage of quiet, clean self propulsion. However, for safety reasons, it is desirable to discharge the HEV energy storage prior to shut down and maintenance. With this in mind, there exist techniques, including location-based energy storage management, that operate the vehicle on stored energy at the end of its duty cycle, discharging the energy storage. Accordingly, there exists need to resolve these conflicting requirements in an efficient and simple way.

### SUMMARY

The present invention includes a system and method for initiating a limited operation mode and operating the hybrid electric vehicle in the limited operation mode. The system includes a user interface associated with the hybrid electric vehicle, an operating mode device and a control module. The user interface is coupled to the operating mode device. The operating mode device is configured to initiate one or more vehicle operation modes. The one or more vehicle operation modes include a first vehicle operation mode, where the first vehicle operation mode is a limited operation mode. The operating mode device is further configured to deactivate a second vehicle operation mode if the second vehicle operation mode is currently active in response to initiating the first vehicle operation mode. The control module is coupled to the operating mode device. In some embodiments the control module is configured to generate commands for limiting the hybrid electric vehicle operational performance characteristics when the hybrid electric vehicle is in the first vehicle operation mode.

In another embodiment a method for initiating a limited operation mode and operating the hybrid electric vehicle in the limited operation mode is described. The process or method starts with providing a user interface that includes an operating mode device. The operating mode device is configured to initiate one or more vehicle operation modes. The process then continues to second step where the first vehicle operation mode of the one or more vehicle operation modes is initiated. The first vehicle operation mode is a limited operation mode. In response to initiating the first vehicle operation mode, a second vehicle operation mode is deactivated if the second vehicle operation mode is currently active. Finally the hybrid electric vehicle operational performance characteristics are limited when the hybrid electric vehicle is in the first vehicle operation mode.

Other features and advantages of the present invention will become more readily apparent to those of ordinary skill in the art after reviewing the following detailed description and accompanying drawings.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a schematic diagram illustrating an embodiment of a hybrid electric vehicle drive system in a series configuration;

FIG. 2A illustrates a functional schematic diagram of an embodiment of a system for operating a hybrid electric vehicle (HEV) in a limited operation mode;

FIG. 2B illustrates a schematic diagram of a conventional start up driver interface in a hybrid-electric metropolitan transit bus;

FIG. 2C illustrates a schematic diagram of an embodiment of an exemplary user-controlled triggering device for initiating a limited operation mode;

FIG. 3 illustrates another functional schematic diagram of an embodiment of a hybrid electric vehicle (HEV) system for initiating a limited operation mode and operating the hybrid electric vehicle in the limited operation mode; and

FIG. 4 is a flow chart of an exemplary method for initiating a limited operation mode and operating the hybrid electric vehicle in the limited operation mode.

### DETAILED DESCRIPTION

The invention is directed toward a system and method for operating a hybrid electric vehicle in the limited operation mode. In particular, the invention relates to a limited operation mode or “taxi mode” in which the vehicle energy storage may enter an alternate EV mode while only having a nominal state of charge and being limited to ferrying and low energy operations.

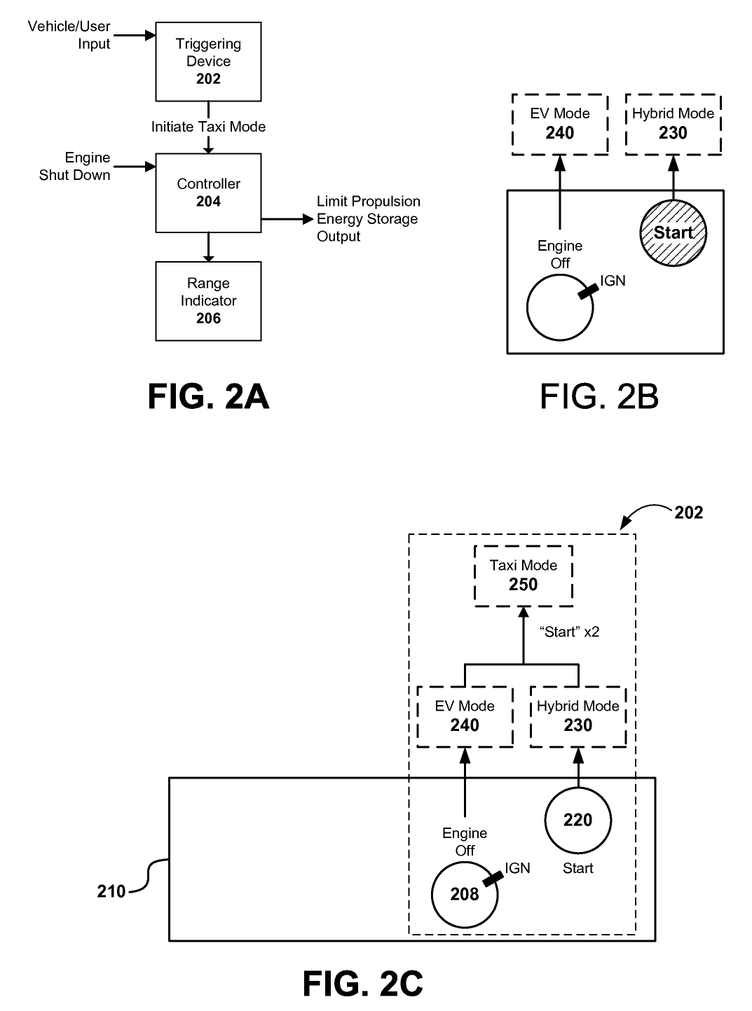

FIG. 2A illustrates a functional schematic diagram of an embodiment of a system for operating a hybrid electric vehicle in a limited operation mode. As discussed above, HEVs may operate in hybrid mode and EV mode, which generally relate to the energy source used to propel the vehicle. However, the limited operation mode or “taxi mode” would be a distinct, third mode of operation. In particular, taxi mode not only relates to the propulsion energy source, it includes a reconfiguration of the hybrid electric vehicle's operational performance characteristics for taxiing or similar operations. For example, while in taxi mode, according to one embodiment, the vehicle would not be able to be driven down the road under normal operating conditions. Accordingly, this mode would be generally used for the beginning and end of a duty or drive cycle, and for emergency operations.

As illustrated, the system includes a triggering device 202 and a controller 204 that is communicatively coupled to triggering device 202. Optionally, the system may include a range indicator 206. Triggering device 202 is configured to initiate a limited operation mode of the hybrid electric vehicle. Controller 204 is configured to require the engine 112 to be shut down and to limit the output of the energy storage 122. Optional range indicator 206 will indicate to the driver to what degree the vehicle may be operated. Preferably, the system will be integrated in a heavy duty hybrid electric vehicle.

The triggering device 202 may be vehicle-operated or user-operated (e.g., by the driver). In particular, according to one embodiment the vehicle will operate the triggering device 202 itself. This operation may include control signals being transmitted from any number of units, controllers, or sensors on the vehicle to trigger or otherwise initiate the limited operation mode. For example, the vehicle may send or receive a signal requesting a switch to taxi mode (limited operation mode) upon entering a designated area, such as a cold weather vehicle maintenance facility or parking structure. This may be accomplished by correlating location information (e.g., via GPS signals, short range wireless communications, etc.) with a trigger or requirement to operate the triggering device 202. For instance, the vehicle may determine that it has entered the designated area by referring to its location and/or by receiving a signal sent by the location itself. This correlation generally would then indicate that the vehicle needs to enter taxi mode. According to this embodiment, triggering device may be triggered automatically without any input from the driver. Optionally, this automatic procedure may also include an additional step of requiring the driver to accept the mode change, or, in the alternate, to give the driver the ability to override the mode change. It is understood that this, and the subsequent examples, are only illustrative, and one or more elements may reside in a single device or across multiple devices. In addition, it is understood that triggering device 202 may reside in hardware, software, or a combination of both.

According to another embodiment, the driver may operate the triggering device. In particular, the triggering device may comprise a user interface and operating mode device wherein a user (e.g., the driver) may command the vehicle to operate in the limited operation mode (taxi mode) as needed. In some embodiments, various operating modes (including the limited operation mode) are independently initiated and controlled by independent user controls (e.g., switches, buttons, etc.). In other embodiments, all or a portion of the various operating modes are initiated and controlled by a single device or control (e.g., switch, button, etc.). In both cases the operation mode changes are user-controlled.

As background, FIG. 2B illustrates a schematic diagram of one embodiment of a conventional start up driver interface in a hybrid-electric metropolitan transit bus. In particular, the start/stop device may include a simple start button (typically green) and which works in conjunction with an engine off/ignition switch. In operation, this preexisting start/stop device is used to initiate the hybrid bus' normal operation mode or “hybrid-mode” 230 by selecting “engine ignition” and pressing the start button. In some applications, this preexisting start/stop device is also used to initiate a hybrid bus EV mode 240 by selecting “engine off”, wherein the vehicle will operate off the energy storage. According to this particular configuration, under normal operation, the start button 220 is unresponsive when repeatedly pressed or engaged after the hybrid-electric vehicle's engine is already running or is in operation.

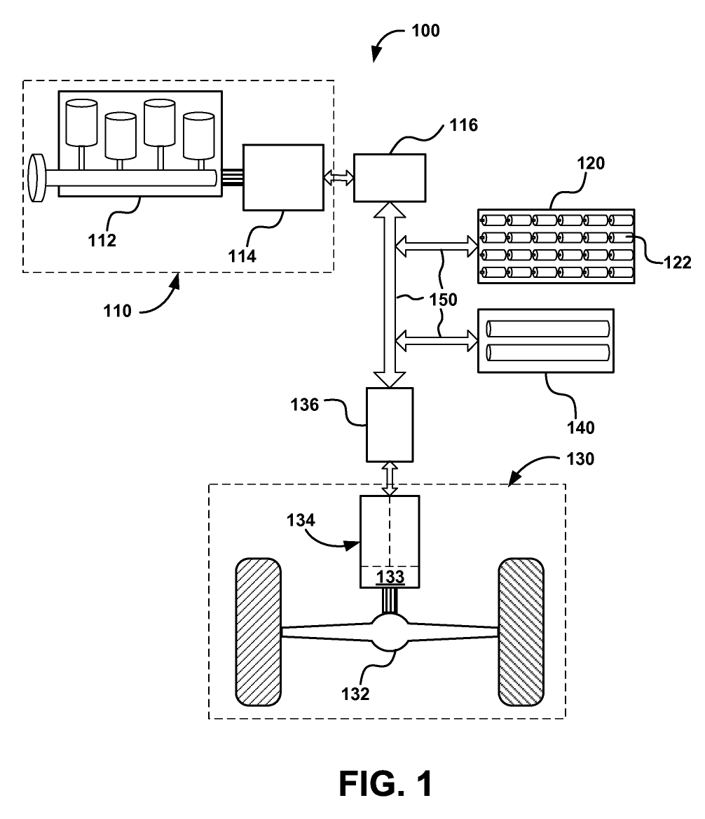

FIG. 2C illustrates a schematic diagram of an embodiment of an exemplary user-controlled triggering device for initiating a limited operation mode 250. Normally, the hybrid electric vehicle includes an operator control system for its HEV drive system 100 (illustrated in FIG. 1), which may include a driver or user interface 210 such as a dashboard control panel and a start/stop device such as a selection button or switch (as discussed above). Here, the operating mode device 220 may be incorporated into the user interface 210 of the hybrid electric vehicle, or separate and independent from the user interface 210. Also, the operating mode device 220 may function with other devices. For example, as illustrated, operating mode device 220 functions in combination with an engine off/ignition switch 208. In some embodiments, the operating mode device 220 may be incorporated into a graphic user interface displayed on the hybrid electric vehicle such as a touch screen (not shown).

As illustrated, it is preferable that the user-controlled triggering device 202 is incorporated into a preexisting hybrid electric vehicle drive system start/stop device. The inventor has discovered that, in this way, drivers face less distraction from a crowded control panel, and will be less burdened with learning how to use additional, unfamiliar controls. Here, the operating mode selection device 220 (which serves as triggering device 202) is configured to initiate one or more vehicle operation modes. Some of the vehicle operation modes may include normal operation mode (hybrid mode) 230, electric vehicle mode (EV-mode) 240 and limited operation mode (taxi mode) 250. It is understood that there are various types of driver interfaces. What is important here is not what layout is used, but rather that existing controls are reused to initiate the limited operation mode.

In one embodiment, the hybrid mode 230, the EV-mode 240 and the taxi mode 250 are initiated or controlled by the same operating mode device 220. For example, normally, when the engine 112 is running, pressing the engine start button 220 will not do anything. If the operator wants to then go to EV mode 240, for example, he must normally engage a separate engine off/ignition switch. With regards to the implementation described herein, when the vehicle is in already in hybrid-mode or EV mode the engine start button 220 may then be reused to initiate the limited operation mode. In particular, if the engine 112 is running, the driver may switch off the engine ignition and press the engine start button 220 with the ignition off. This will cause then the hybrid electric vehicle to enter the taxi mode 250 as discussed above. Likewise, if the engine 112 is not running and the vehicle is already in EV mode 240, the driver may press the engine start button 220 and the hybrid electric vehicle will enter the taxi mode 250 as discussed above. Alternately, all functionality may reside in the start button such that pressing the start button while the engine is running will both shut down the engine and switch to taxi mode 250. Accordingly, pressing engine start button 220 may deactivate the active vehicle operation mode by turning off the engine 112 of the hybrid electric vehicle and reconfiguring its performance as required, or just reconfiguring its performance as required.

This implementation is beneficial because, not only will the driver now have the additional functionality of a low output mode such as the taxi mode 250, but the vehicle control complexity is not increased. In particular, by using the same start button 220 used for starting up the engine no new devices are required. The additional simplicity also allows the driver to give minimal attention to the driver controls. Additionally, since taxiing is usually associated with process of ending the drive cycle, and since pressing the start button is normally not required near the time of vehicle shut down, especially not when the engine is already on, inadvertently entering taxi mode 250 is highly unlikely.

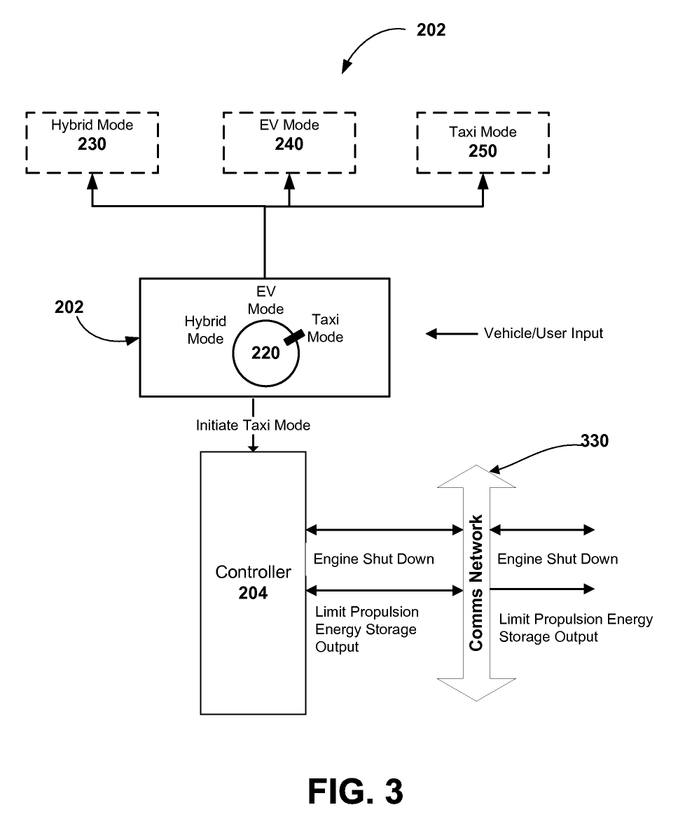

FIG. 3 illustrates another functional schematic diagram of an embodiment of a system for operating a hybrid electric vehicle in a limited operation mode. As previously described, the triggering device 202 is associated with controller 204. The controller or control module 204 is communicatively coupled to the triggering device 202, and may include operation mode selection device 220, and is configured to select between the various vehicle operation modes. In the taxi mode 250, for example, the controller 204 may be configured to generate commands for modifying the hybrid electric drive system operational performance settings. In other embodiments, the controller 204 may be configured to implement a taxi mode algorithm that limits the operation of the vehicle.

It is understood that the controller 204 as described herein is better identified by its function rather than any one particular embodiment. For example, controller 204 may be integrated with triggering device 202, may be integrated with other drive system controls, and/or may be embodied as a discrete control device (such as in hardware and/or software). In some embodiments, the controller 204 is implemented as, for example, a central processing unit with memory, such as random access memory and/or read only memory.

According one preferred embodiment, the controller 204 may communicate the drive system reconfiguration commands and/or vehicle operation limiting algorithms over a vehicle communication network 330. Typically, vehicle communication network 330 will include a communication bus such as with a Controller Area Network (CAN). The vehicle communication network 330 may include multiple tiered dedicated communication networks. For example, the vehicle communication network 330 may include a CAN bus for vehicle communications, a CAN bus for drive system communications, and a CAN bus for energy storage communications, wherein the multiple networks may be ported into each other in a tiered manner. Furthermore, the vehicle network 330 may include multiple communication protocols. For example, the vehicle communication network may include overall network communications (e.g., J1939, CAN, OBD-II, etc.), remote telemetry communications (e.g., GPRS, GSM, CDMA, etc.), and local standardized (e.g., SPI, LIN, etc.) or proprietary communications. By having access to the various comms networks, the controller 204 may communicate the configuration parameters and/or operation limiting commands directly or indirectly (e.g., to the vehicle energy storage 120, to the engine genset 110, etc.) to the vehicle subsystems

In operation, the controller 204 will require the internal combustion engine 112 to be shut down and will reconfigure the hybrid electric vehicle to operate in the limited operation mode 250. In requiring the engine 112 to be shut down, the controller 204 may actively shut down the engine 112, may passively require the engine 112 to be shut down, or both. For example, with a user-controlled triggering device, when the engine 112 is running, controller 204 may actively require the driver to shut down the engine 112 first, which may be integrated into the taxi-mode request. Similarly, with a vehicle-controlled triggering device 202, controller 204 may actively shut down the engine 112. However, it may still be desirable to require the driver to first grant permission for the controller 204 to shut down the engine 112. Both manual shut down and permission granting may be realized using the drive controls 220, 208 described above. Also for example, controller 204 may passively require the engine 112 to be shut down as a precondition to entering the limited operation mode 250. For example, if the engine is not running, controller 204 will confirm that the engine 112 is shut down. This is particularly useful when the vehicle taxi mode 250 is requested at vehicle start or when the vehicle is already in EV mode 240 and the engine is not running.

In reconfiguring the hybrid electric vehicle to operate in the limited operation mode 250, generally, the controller 204 places a limitation on the output of the propulsion energy storage 122 in response to the triggering device 202 initiating the limited operation mode 250. More particularly, limiting the output of the propulsion energy storage 122 is associated with the limited performance of the taxi mode 250. For example, the controller may adjust or limit the amount of energy the propulsion energy storage may hold, the controller may limit a demand for energy from the propulsion energy storage, the controller may limit the amount of energy that may be delivered to the vehicle, and the controller may limit where on the vehicle energy from the propulsion energy storage may go. In these and similar ways, the limits placed on the output of the propulsion energy will in turn limit the performance of the vehicle and provide for sustained operations in the taxi mode 250.

According to one embodiment, the controller 204 may adjust or limit the amount of charge the energy storage 122 may hold. In a hybrid vehicle, the propulsion energy storage typically is maintained in an optimal state of charge (SOC) range that balances factors such as: available acceleration power, braking regeneration capacity, avoidance of memory effect, energy storage state of health (SOH), etc. Here, the controller 204 may reestablish the SOC limits of the propulsion energy storage 122 to reflect a limited performance mode 205. For example, the controller 204 may modify the maximum allowable SOC and/or the minimum required SOC as set in the vehicle battery management system (BMS). It is understood that this modification may similarly apply to an ultracapacitor based system, as well as to a propulsion energy storage 122 that manages its SOC though other controllers, such as through a main hybrid drive system controller.

According to one embodiment, the controller 204 may lower the upper SOC target or otherwise create a maximum allowable charge for the energy storage. For example, the controller 204 may reestablish the upper SOC target and require a maximum allowable threshold SOC of no more than 25 percent of the propulsion energy storage's capacity as part of limiting the amount of charge the energy storage 122 may hold. In doing so, controller 204 may communicate CAN messages to the BMS (or other controller), resetting the top SOC. Thus, by lowering the max allowable charge, the vehicle may lower its stored propulsion energy. This may be beneficial in anticipation of a pending vehicle shut down and/or maintenance, thus creating safer vehicle environment. In addition, propulsion energy storage 122 discharge may be used to increase its lifetime, for example were the propulsion energy storage 122 is Li-ion based,

Similarly, according to one embodiment, the controller 204 may lower the minimum SOC target or create a minimum required charge for the energy storage 122. In particular, the controller 204 may require the propulsion energy storage 122 to be charged up to a minimum required threshold associated with vehicle operation in taxi mode 250. For example, the controller 204 may reestablish the minimum SOC target and require a minimum required threshold SOC of no less than 10 percent of the propulsion energy storage's capacity to ensure there is sufficient stored energy for taxiing operations. It is understood that the minimum stored energy may vary according to the vehicle range requirements and the associated vehicle performance.

Where the propulsion energy storage SOC limits are not readily accessible (e.g., where they are hard-coded in the energy storage), the SOC may be modified indirectly by modifying a more accessible Start-Stop or Idle-Stop algorithm. The Idle-Stop algorithm controls the engine 112 such that the engine shuts down when the energy storage 122 has reached a predetermined SOC, and may consider energy demands of the vehicle. In addition, the Idle-Stop algorithm will start up the engine when the SOC is too low, and may consider energy demands of the vehicle. Here, controller 204 may access and modify the SOC limited in a preexisting Idle-Stop algorithm instead of directly, and independently initiating a shut-down sequence. Also, in addition to being more accessible from a controls standpoint, using the Idle-Stop to initiate the taxi mode sequence, the controller 204 may efficiently reuse preexisting engine algorithms by merely changing the high SOC parameter.

According to one embodiment, when the propulsion energy storage 122 is overcharged, with respect to taxi mode 250, the Idle-Stop algorithm may initiate the engine shut down prematurely and run in full EV mode 240 until the maximum allowable threshold is reached. By running in full EV 240, maximum energy storage depletion is available without losing stored energy. Once the maximum allowable threshold is reached, the vehicle may reconfigure itself to operate in taxi mode 250.

Similarly, according to one embodiment, when the propulsion energy storage 122 is undercharged, with respect to taxi mode 250, the Idle-Stop algorithm may initiate the engine start-up prematurely and run the generator at capacity until the minimum required threshold SOC is reached. Once the minimum required threshold SOC is reached, the vehicle may reconfigure itself to operate in taxi mode 250.

According to one embodiment, when the energy storage is charged above the maximum allowable threshold, the controller 204 may further require the propulsion energy storage 122 to be discharged to a maximum allowable threshold associated with the limited operation mode 250 and a predetermined drivable range of the hybrid electric vehicle. For example, where rapid reconfiguration to taxi mode 250 is desired, the maximum allowable SOC may be reached quickly by discharging the energy storage 122. In particular, the controller 204 may communicate messages (e.g., CAN) to command a drive system energy flow controller to electrically couple a braking resistor 140 to the DC bus 150. This will dissipate stored energy from the propulsion energy storage 122 (contrasted with the excess from the electric motor(s) 134). Once the propulsion energy storage 122 has fallen to the maximum allowable SOC, the braking resistors 140 are decoupled from the DC bus 150.

According to one embodiment, the controller 204 may limit the power outputted from the propulsion energy storage 122. In particular, the controller 204 may limit a demand for energy from the propulsion energy storage 122, and/or the controller 204 may limit the amount of energy that may be delivered to the vehicle. For example, the controller 204 may limit the driver from requesting power by notifying the driver, or by governing the vehicle controls. Also for example, the controller may modify a request for power to a lesser demand or may scale the power supplied in response to a request. Limiting the power outputted may further include modifying the hybrid electric vehicle operational performance characteristics, such as reconfiguring a performance parameter of one or more subsystems of the hybrid electric vehicle. The reconfiguration may be implemented by the control module 204.

According to one embodiment, the propulsion energy storage 122 may include a governor on at least one of speed, acceleration, and jerk of the hybrid electric vehicle and/or its subsystems. For example, the controller 204 may be configured to prevent the hybrid electric vehicle from traveling past 5-10 miles per hour, accelerating past 2.5 feet per second squared, and/or jerking more than 3.5 feet per second cubed. Performance limitations such as these reflect a limited mode of operation associated with taxiing a vehicle, at a fraction of over-the-road driving characteristics. Furthermore and may be achieved via the controller 204, modifying one or more vehicle performance parameters, and/or limiting power to the electric drive motor(s) 134 accordingly.

Similarly, the controller 204 may be configured to allow the hybrid electric vehicle to travel a limited range. In particular, controller 204 may ensure sufficient energy is stored so that the vehicle may travel a predetermined range. For example, when entering taxi mode the vehicle may have energy to travel no more than 500 feet. This limited range may include a power profile as well. For example, when entering taxi mode the vehicle may have energy to travel for a distance of 100 yards or less calculated with the vehicle going 5 mph or less. In certain embodiments, this range may be adjusted by a user to accommodate the taxiing profile.

According to one embodiment, the controller 204 may limit where on the vehicle energy from the propulsion energy storage 122 may go. In particular, the controller 204 may disable one or more subsystems not required to propel the hybrid electric vehicle. For example, operations such as, air conditioning, heater, etc. may be temporarily deactivated during the taxi mode 250. As such, initiating a taxi mode 250 may include the control module 204 generating commands for deactivating or locking off all subsystems not directly related to propelling the hybrid electric vehicle. Preferably shutting down and/or preventing from operation at least one subsystem of the hybrid electric vehicle would include an environmental control subsystem. However, not every non-propulsion-related subsystem need be deactivated. Instead, it may be beneficial to only disable larger subsystems, such as those which can draw more than 1 kW of power from the propulsion energy storage. It is understood that the object is to minimize electric load however there may be circumstances where a small number of subsystems are of sufficient priority that they may need to remain on despite not being necessary for the propulsion of the vehicle.

According to one preferred embodiment, the vehicle will include a user interface configured to communicate information associated with the limited operation mode to the driver. In particular, the user interface may indicate that taxi mode is engaged, the vehicle output available, and instructions for conforming to the limited operation mode. For example, the start/stop button may give a visual indication by changing color or a tactile indication including a physical change such as extending outwardly, or it may give an auditory indication when pressed. In addition, selection of taxi mode 250 may include an indication to the driver of the hybrid electric vehicle of an approximate operational distance based on nominal conditions (e.g., unloaded vehicle, low continuous speed, level surface, etc.). Where the system includes a range indicator, the controller 204 may calculate a drivable range of the hybrid electric vehicle that is associated with the reconfiguration of the hybrid electric vehicle and a state of charge of the propulsion energy storage. The range indicator would then indicate to the driver the calculated drivable range of the hybrid electric vehicle. In one embodiment, pressing the operating mode device 220 (such as the start/button) may initiate a reverse odometer that counts down from, for example, 1 mile in tenths of a mile, or any value appropriate to the user.

The taxi mode 250 may also issue a warning to a driver of the hybrid electric vehicle that the vehicle energy storage 122 is not sufficiently charged for taxi mode 250, for example. The controller 204 may be further configured to indicate the state of charge (SOC) to a driver or just that the state of charge of the propulsion energy storage 122 is not charged to the minimum threshold associated with the limited operation mode. If the vehicle begins to get dangerously close to discharging its energy storage for operating the taxi mode 250, the system may also warn the driver of this as well. According to one embodiment, the controller 204 may be further configured to provide the driver with the option to override the requirement that the propulsion energy storage be charged to the minimum threshold associated with the limited operation mode.

According to one embodiment, the controller 204 may limit the driver from requesting power by notifying the driver of what subsystem must be manually shut down and/or at what point his operation of the vehicle is in conflict of the taxi mode. In particular, the system may rely on interaction with the driver to operate. For example, once in taxi mode 250, the driver may be required to manually shut down certain subsystems prior to engaging the drive system. Alternately, if the driver over accelerates or drives too fast, the controller may issue a strong alert, compelling the driver to comply with the taxi mode requirements. In this way, the drive retains maximum control and the system requires a minimum vehicle control strategy.

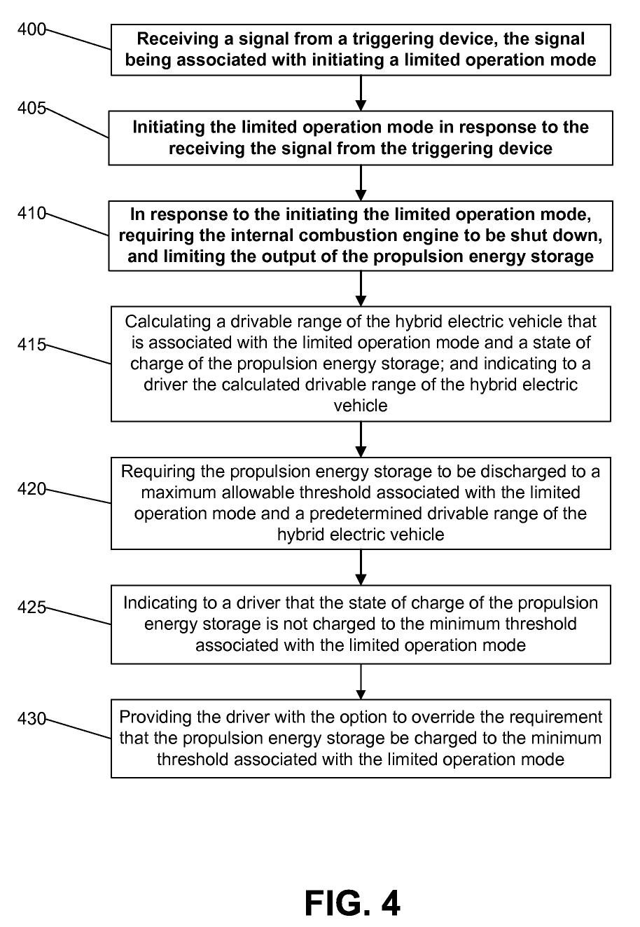

FIG. 4 is a flow chart of an exemplary method for operating a hybrid electric vehicle. In particular, the method includes initiating a limited operation mode and operating the hybrid electric vehicle in the limited operation mode. The method can be implemented in the system described above and in FIGS. 2A-C and 3.

The process starts at block 400, with receiving a signal from a triggering device, the signal being associated with initiating a limited operation mode. As described above, the triggering device 202 may be user-controlled or vehicle-controlled (i.e., automatic). The process then continues to block 405, initiating the limited operation mode in response to the receiving the signal from the triggering device. As described above, the limited operation mode is associated with a reconfiguration of the vehicle drive system such as a taxi mode 250, where the vehicle no longer is able to operate over-the-road, but rather can operate in ferrying activities such as returning to a parking or maintenance location. In block 410, in response to the initiating the limited operation mode 405, the method includes requiring the internal combustion engine 112 to be shut down, and limiting the output of the propulsion energy storage 122 as described in the system above.

According to one embodiment, the method may further include step 415, calculating a drivable range of the hybrid electric vehicle that is associated with the limited operation mode and a state of charge of the propulsion energy storage 122; and indicating to a driver the calculated drivable range of the hybrid electric vehicle. This will be distinct from an indication of fuel in the vehicle, which, in most cases will have a much greater range. As described above, the vehicle may have variable ranges, depending on the taxiing parameters selected for the vehicle.

According to one embodiment, the method may further include step 420, requiring the propulsion energy storage to be discharged to a maximum allowable threshold associated with the limited operation mode and a predetermined drivable range of the hybrid electric vehicle. As described above, the energy storage 122 may be discharged via the vehicle's regenerative braking resistors 140.

According to one embodiment, the method may further include step 425, indicating to the driver that the state of charge (SOC) of the propulsion energy storage 122 is not charged to the minimum threshold associated with the limited operation mode. As described above, in some cases the method may further include providing the driver with the option to override the requirement that the propulsion energy storage be charged to the minimum threshold associated with the limited operation mode 430.

Those of skill will appreciate that the various illustrative logical blocks, modules, and algorithm steps described in connection with the embodiments disclosed herein can often be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the design constraints imposed on the overall system. Skilled persons can implement the described functionality in varying ways for each particular application, but such implementation decisions should not be interpreted as causing a departure from the scope of the invention. In addition, the grouping of functions within a module, block or step is for ease of description. Specific functions or steps can be moved from one module or block without departing from the invention.

The various illustrative logical blocks and modules described in connection with the embodiments disclosed herein can be implemented or performed with a general purpose processor, a digital signal processor (DSP), application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

The steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium. An exemplary storage medium can be coupled to the processor such that the processor can read information from, and write information to, the storage medium. In the alternative, the storage medium can be integral to the processor. The processor and the storage medium can reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments and that the scope of the present invention is accordingly limited by nothing other than the appended claims.

1. A system for operating a hybrid electric vehicle, the hybrid electric vehicle having an internal combustion engine and a propulsion energy storage, the system comprising:
a triggering device configured to initiate a limited operation mode of the hybrid electric vehicle; and,
a controller communicatively coupled to the triggering device, the controller configured to require the internal combustion engine to be shut down and to reconfigure the hybrid electric vehicle by placing a limitation on the output of the propulsion energy storage in response to the triggering device initiating the limited operation mode.

2. The system of claim 1, wherein the triggering device comprises a user interface configured to receive a user input associated with initiating the limited operation mode.

3. The system of claim 2, wherein the triggering device is further configured to initiate an electric vehicle mode of the hybrid electric vehicle that is distinct from the limited operation mode and does not include the limitation of the output of the propulsion energy storage;
wherein the user input associated with initiating the limited operation mode is also associated with initiating the electric vehicle mode; and,
wherein repeating the user input will switch between initiating the electric vehicle mode and initiating the limited operation mode.

4. (canceled)

5. The system of claim 1, wherein the limitation on the output of the propulsion energy storage includes limiting a demand for energy from the propulsion energy storage.

6. (canceled)

7. The system of claim 5, wherein limiting the demand for energy from the propulsion energy storage comprises shutting down and/or preventing from operation at least one subsystem of the hybrid electric vehicle, and the at least one subsystem of the hybrid electric vehicle comprises an environmental control subsystem.

8. The system of claim 5, wherein limiting the demand for energy from the propulsion energy storage comprises shutting down and/or preventing from operation at least one subsystem of the hybrid electric vehicle, and the at least one subsystem of the hybrid electric vehicle comprises substantially all subsystems that can draw more than 1 kW of power from the propulsion energy storage and are not necessary for the propulsion of the vehicle.

9. The system of claim 1, wherein the limitation on the output of the propulsion energy storage includes a governor on at least one of speed, acceleration, and jerk of the hybrid electric vehicle.

10. The system of claim 9, wherein the governor on at least one of speed, acceleration, and jerk of the hybrid electric vehicle is configured to prevent the hybrid electric vehicle accelerating past ten miles per hour.

11. (canceled)

12. (canceled)

13. The system of claim 1, wherein the controller is further configured to require the propulsion energy storage to be discharged to a maximum allowable threshold associated with the limited operation mode and a predetermined drivable range of the hybrid electric vehicle, and the hybrid electric vehicle includes a braking resistor and the controller is further configured to discharge the propulsion energy storage via the braking resistor to the maximum allowable threshold in response to the triggering device initiating the limited operation mode.

14. (canceled)

15. The system of claim 1, wherein the controller is further configured to require the propulsion energy storage to be charged to a minimum threshold associated with the limited operation mode in response to the triggering device initiating the limited operation mode and to indicate to a driver that the state of charge of the propulsion energy storage is not charged to the minimum threshold associated with the limited operation mode, wherein the controller is further configured to provide the driver with the option to override the requirement that the propulsion energy storage be charged to the minimum threshold associated with the limited operation mode.

16. A method for operating a hybrid electric vehicle, the hybrid electric vehicle having an internal combustion engine and a propulsion energy storage, the hybrid electric vehicle configured to operate according to two or more operating modes, the method comprising:
receiving a signal from a triggering device, the signal being associated with initiating a limited operation mode;
initiating the limited operation mode in response to the receiving the signal from the triggering device; and,
in response to the initiating the limited operation mode, requiring the internal combustion engine to be shut down, and limiting the output of the propulsion energy storage.

17. The method of claim 16, wherein the triggering device comprises a user interface, the method further comprising receiving a user input associated with initiating the limited operation mode.

18. (canceled)

19. (canceled)

20. The method of claim 16, wherein the limiting the output of the propulsion energy storage comprises limiting a demand for energy from the propulsion energy storage.

21. (canceled)

22. The method of claim 20, wherein limiting the demand for energy from the propulsion energy storage comprises shutting down and/or preventing from operation at least one subsystem of the hybrid electric vehicle; and the at least one subsystem of the hybrid electric vehicle comprises an environmental control subsystem.

23. The method of claim 20, wherein limiting the demand for energy from the propulsion energy storage comprises shutting down and/or preventing from operation at least one subsystem of the hybrid electric vehicle; and the at least one subsystem of the hybrid electric vehicle comprises substantially all subsystems that can draw more than 1 kW of power from the propulsion energy storage and are not necessary for the propulsion of the vehicle.

24. The method of claim 16, wherein the limiting the output of the propulsion energy storage comprises limiting at least one of speed, acceleration, and jerk of the hybrid electric vehicle.

25. The method of claim 24, wherein the limiting at least one of speed, acceleration, and jerk of the hybrid electric vehicle includes preventing the hybrid electric vehicle from accelerating past ten miles per hour.

26. The method of claim 16 further comprising:
calculating a drivable range of the hybrid electric vehicle that is associated with the limited operation mode and a state of charge of the propulsion energy storage;
indicating to a driver the calculated drivable range of the hybrid electric vehicle.

27. (canceled)

28. The method of claim 16, further comprising requiring the propulsion energy storage to be discharged to a maximum allowable threshold associated with the limited operation mode and a predetermined drivable range of the hybrid electric vehicle; and,
wherein the hybrid electric vehicle includes a braking resistor, the method further comprising discharging the propulsion energy storage via the braking resistor to the maximum allowable threshold in response to the initiating the limited operation mode.

29. (canceled)

30. The method of claim 16, further comprising:
requiring the propulsion energy storage to be charged to a minimum threshold associated with the limited operation mode in response to the initiating the limited operation mode;
indicating to a driver that the state of charge of the propulsion energy storage is not charged to the minimum threshold associated with the limited operation mode; and,
providing the driver with the option to override the requirement that the propulsion energy storage be charged to the minimum threshold associated with the limited operation mode.
